(19) United States
(12) Patent Application Publication
(10) Pub. No.: US 2008/0074884 A1
(43) Pub. Date: Mar. 27, 2008

(54) Compact high-intensty LED-based light source and method for making the same

(76) Inventors: Thye Linn Mok, Bukit Mertajam Penang (MY); Tong Fatt Chew, Bayan Lepas (MY)

Correspondence Address: Kathy Manke;Avago Technologies Limited, 4380 Ziegler Road, Fort Collins, CO, 80525, US

(21) Appl. No.: 11/527,111

(22) Filed: Sep. 25, 2006

(51) Int. Cl. F21V 29/00

(52) U.S. Cl. 362/294

(57) ABSTRACT

A LED based light source and method for making the same are disclosed. The light source includes a plurality of LEDs, an LED carrier, and a cover. The LED carrier includes a metallic core having a top surface bonded to a circuit layer having mounting pads for each of the LEDs and a connector that provides connections to circuit conductors connected to the mounting pads. The cover is bonded to the LED carrier and includes a first opening positioned to allow light from the LEDs to leave the cover and a second opening that provides access to the connector. An encapsulant system covers each of the LEDs with a layer of encapsulant material. The encapsulant system bonds the cover to the LED carrier and can provide optical processing of the light from the LEDs.

### BACKGROUND OF THE INVENTION

Light-emitting diodes (LEDs) are attractive replacement candidates for conventional light sources based on incandescent bulbs and fluorescent light tubes. LEDs have higher energy conversion efficiency than incandescent lights and substantially longer lifetimes than both incandescent and fluorescent light fixtures. In addition, LED-based light fixtures do not require the high voltages associated with fluorescent lights.

LEDs are particularly attractive light sources for backlit displays such as LCD panels that have space constraints. Many mobile electronic devices require a very thin backlight source. LCD displays for use in cellular telephones, PDAs, and laptop computers require a light source for illuminating an LCD panel or keypad. The light source typically consists of a thin two-dimensional flat light pipe that is illuminated from an edge or edges of the thin layer. Light is trapped within the light pipe by internal reflection until the light is scattered by scattering centers on one of the surfaces. The scattered light exits the light pipe through one surface of the light pipe and is used to illuminate a two-dimensional object such as an LCD panel or keypad.

Portable devices place severe constraints on the thickness of the light source. The minimum thickness of the device is set by the combined thickness of the light pipe and the object being illuminated. Ideally, the light source that is used to illuminate the edge of the light pipe is less than this minimum thickness so that the LEDs do not increase the thickness of the device. Since LEDs are inherently small light emitters that can operate on the low voltages available in such portable devices, light sources based on LEDs are of great interest in such applications.

Unfortunately, LEDs have a number of problems that must be overcome to provide a cost-effective solution in such backlight systems. First, LEDs are relatively low power point sources. The backlighting applications require a light source that has a linear geometry and more power than is available from a single LED. Hence, a light source having a relatively large number of individual LEDs must be constructed.

Second, LEDs emit light in narrow optical bands. Hence, to provide a light source that a human observer will perceive as having a particular color, LEDs having different emission spectra must be combined into the same light source or phosphor conversion layers must be utilized to convert some of the LED generated light to light of a different spectrum. For example, an LED that is perceived to emit white light can be constructed by combining the output of LEDs having emission spectra in the red, blue, and green region of the spectrum or by utilizing a blue emitting LED and a layer of phosphor that converts some of the output light to light in the yellow region of the spectrum. For LCD displays, lights that have emission bands in the red, blue, and green regions of the spectrum are typically required. Hence, an LED-based light source must include three types of LEDs and provide for the mixing of the light from three separate sources.

Third, heat dissipation is particularly important in the case of LED-based light sources. The electrical conversion efficiency of an LED decreases with increasing junction temperature in the LED. Hence, any LED-based light source that generates a significant amount of heat must have a good thermal conduction path for removing the heat from the LED.

Finally, cost is of prime importance in most of these applications. In many prior art systems, the light source is constructed from individual LEDs that are incorporated on the printed circuit board (PCB) used to implement other parts of the mobile device. Such custom designs increase the cost of the design as well as the product cycle time.

### BRIEF DESCRIPTION OF THE DRAWINGS

FIG. 1 is a top front perspective view of light source 30.

FIG. 2 is a bottom front perspective view of light source 30.

FIG. 3 is an exploded perspective view of light source 30.

FIG. 4 is a top view of light source 30.

FIG. 5 is a cross-sectional view of light source 30 through line 5-5 shown in FIG. 4.

FIGS. 6A and 6B illustrate connection schemes in which the individual LEDs of each color are connected in series.

FIG. 7 is a top view of a portion of another embodiment of the present invention showing a portion of the opening through which light from the LEDs escapes.

FIG. 8 is a cross-sectional view of a portion of another embodiment of a light source according to the present invention.

FIG. 9 is a cross-sectional view of a portion of another embodiment of a light source according to the present invention.

FIG. 10 is a partial cross-sectional view of another embodiment of a light source according to the present invention.

FIG. 11 is a cross-sectional view of a portion of another embodiment of a light source according to the present invention.

FIG. 12 is a top view of another embodiment of a light source according to the present invention.

FIG. 13 is a top view of another embodiment of a light source according to the present invention.

FIG. 14 is a top view of another embodiment of a light source according to the present invention.

FIG. 15 is a partial cross-sectional view of the light source shown in FIG. 14.

### SUMMARY OF THE INVENTION

The present invention includes a light source and method for making the same. The light source includes a plurality of LEDs, an LED carrier, and a cover. The LED carrier includes a metallic core having a top and bottom surface. The top surface is bonded to a circuit layer having mounting pads for each of the LEDs and a connector that provides connections to circuit conductors connected to the mounting pads. The bottom surface includes an external boundary of the light source. The cover is bonded to the LED carrier. The cover includes a first opening positioned to allow light from the LEDs to leave the cover and a second opening that provides access to the connector. An encapsulant system covers each of the LEDs with a layer of encapsulant material. In one aspect of the invention, the cover includes a cavity, the LED carrier being bonded to an inside surface of the cavity and aligned to the cover by the walls of the cavity. In another aspect of the invention, the encapsulant system includes a layer of clear encapsulant having a first surface in contact with the LEDs and the LED carrier and a second surface that is molded. The molded surface can be flat or shaped to provide optical processing of the light from the LEDs.

### DETAILED DESCRIPTION OF EMBODIMENTS OF THE INVENTION

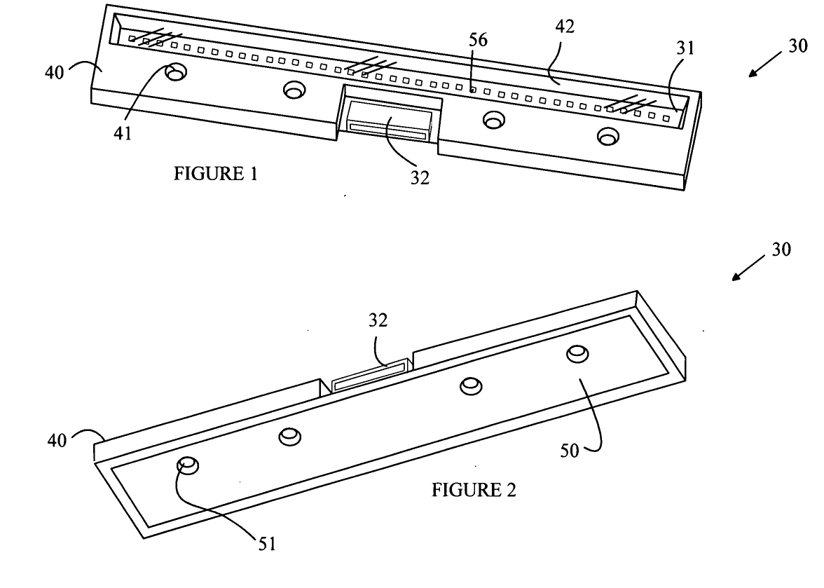

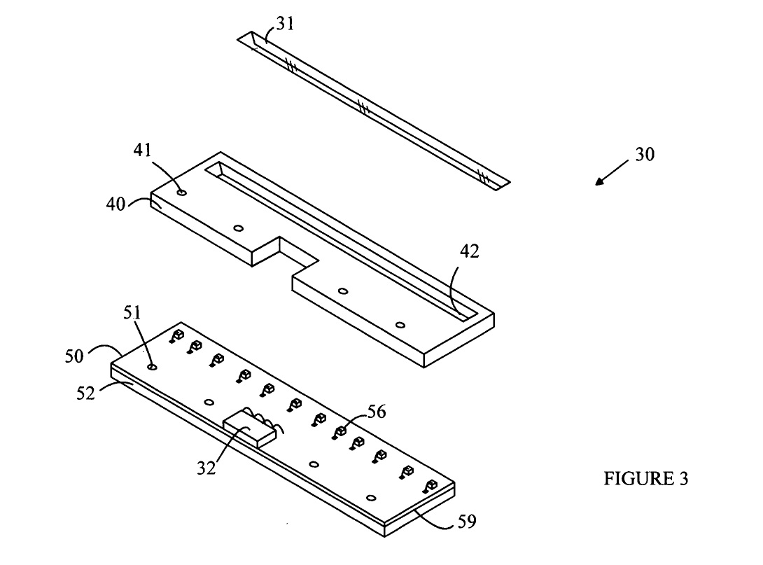

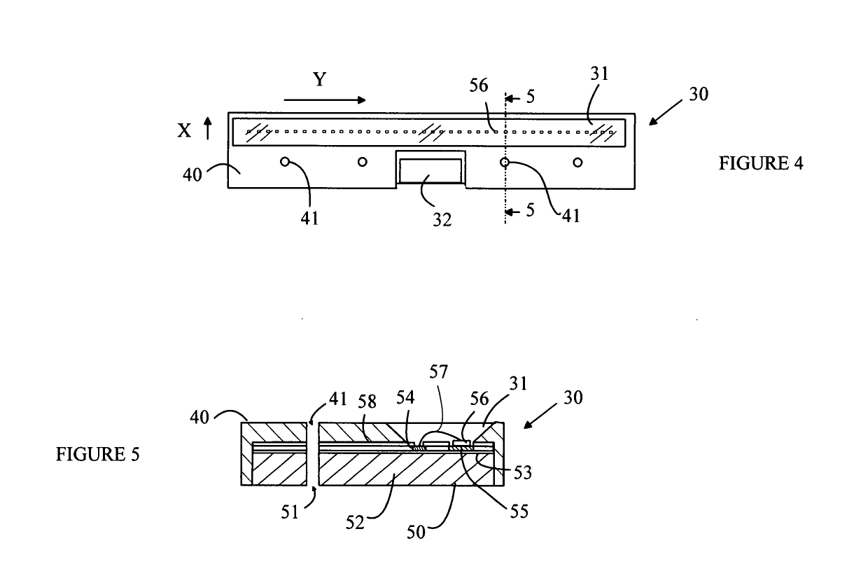

The manner in which the present invention provides its advantages can be more easily understood with reference to FIGS. 1-5, which illustrate one embodiment of a light source according to the present invention. FIG. 1 is a top front perspective view of light source 30, and FIG. 2 is a bottom front perspective view of light source 30. FIG. 3 is an exploded perspective view of light source 30. FIG. 4 is a top view of light source 30, and FIG. 5 is a cross-sectional view of light source 30 through line 5-5 shown in FIG. 4.

Light source 30 includes two main assemblies, a LED carrier 50 and a cover 40. Cover 40 includes a cavity into which LED carrier 50 is inserted. Cover 40 also includes an opening 42 through which light from the LEDs shown at 56 can exit light source 30. The sides of opening 42 are reflective and slanted at an angle to redirect light leaving the LEDs through the side thereof to a direction that allows that light to exit from light source 30. Light source 30 includes a transparent encapsulant member that fills opening 42.

Led carrier 50 is a circuit carrier 59 that is constructed from one or more metal layers that are patterned to provide the connections between the various electronic components in light source 30. The circuit layers are bonded to a metal core 52 that transfers heat from the LEDs to cover 40 and to the underlying structures on which light source 30 is mounted. In one embodiment, the core is constructed from an aluminum alloy. In the embodiment shown in FIGS. 1-5, a single metal layer is patterned to provide the traces 54 and 55 used to connect LED 56 to power through connector 32. This layer is separated from core 52 by a thin insulating layer 53 that is less than or equal to 4 mils thick. The metal layer is covered by a second thin insulating layer 58 that prevents the signal traces in the metal layer from shorting to cover 40.

The connector can be either a male or female connector that is configured to mate to a corresponding connector on a cable or other device in the apparatus in which the light source is utilized. In the above-described embodiments, the connector is positioned to receive the corresponding connector in a direction parallel to the surface of the LED circuit carrier. However, embodiments in which the connector is mounted such that the corresponding connector is received in a direction perpendicular to that surface could also be constructed.

Each LED is connected to two traces within the metal layer. The first connection is provided by a terminal on the bottom of the LED, and the second connection is provided by a terminal on the top of the LED through a wire bond connection 57.

Light source 30 includes three groups of LEDs. The LEDs in each group are connected in series and generate light having the same spectrum. The groups generate light in the red, blue, and green regions of the spectrum. To improve the color uniformity of the output light, the LEDs alternate such that each LED has a neighboring LED of the other two colors. Each group of LEDs is connected to connector 32 by a corresponding trace in the metal layer.

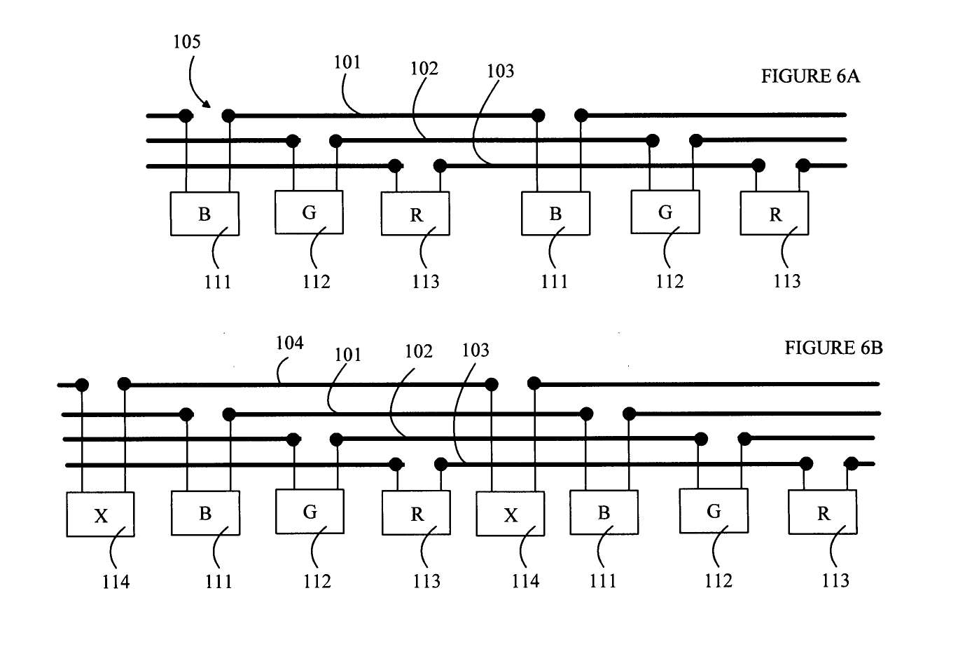

Refer now to FIG. 6A, which illustrates a connection scheme in which the individual LEDs of each color are connected in series. In this arrangement, the metal layer shown in FIG. 5 includes three metal traces 101-103 that include gaps such as gap 105 at each point at which an LED is to be connected. All of the blue LEDs 111 are connected to trace 101 such that the LED completes the circuit across one of the gaps in trace 101. Similarly, the green LEDs 112 are connected across the gaps in trace 102, and the red LEDs 113 are connected across the gaps in trace 103. The ends of each trace are connected to conductors in connector 32.

While the embodiment shown in FIG. 6A has 3 groups of LEDs, embodiments having other numbers of groups are also useful in particular situations. For example, a monochrome source requires only one group of LEDs. Furthermore, embodiments that have 4 groups of LEDs provide a number of advantages. Refer now to FIG. 6B, which illustrates the connection scheme shown in FIG. 6A expanded to include an additional group of LEDs, denoted by “X”. The additional group is implemented by providing an additional conductor 104 that has gaps for the new group of LEDs shown at 114.

In one embodiment, X is an additional green LED. The relative efficiency of green LEDs is significantly less than that of red and blue LEDs. Hence in embodiments in which the LEDs are to be operated close to the maximum rated currents, additional green LEDs are needed to provide the same range of colors and still maintain the red and blue LEDs at near the maximum current for those LEDs.

In another embodiment, X is a “white” LED. White LEDs, based on blue LEDs that are covered by a yellow phosphor that converts part of the blue light to yellow light, have a higher power conversion efficiency than white light sources constructed from red, blue, and green LEDs. However, in many applications, a white light source that has a limited range of color tuning around the white light provided by the white LED is useful.

In yet another embodiment, X is an amber or cyan LED. Such light sources have a wider color gamut, and hence are useful in specific applications that require color points in the amber or cyan regions of the color space.

Cover 40 includes a cavity into which LED carrier 50 is inserted such that the bottom surface of LED carrier 50 is flush with the bottom surface of cover 40. This provides an arrangement that maximizes the heat transfer surfaces of light source 30 and the surface to which light source 30 is connected in the final product that utilizes light source 30. Cover 40 is affixed to the LED carrier by encapsulant 31, which is used to fill opening 42 after cover 40 and LED carrier 50 have been assembled. The encapsulant layer bonds to the top surface of LED carrier 50 and the slanted sides of opening 42. Additional adhesive can be applied to the top surface of LED carrier 50 to provide bonding in the other regions of contact if the bonding provided by the encapsulant layer is insufficient.

Light source 30 also includes a number of holes that are provided for mounting light source 30 on other assemblies in the completed product in which light source 30 is utilized. Cover 40 includes holes 41 that are aligned with holes 51 in LED carrier 50 to provide holes through light source 30 that can accommodate a fastener such as a screw. The inside surfaces of holes 41 and/or 51 can be threaded to facilitate such attachment as shown at 48 in FIG. 5. Embodiments in which the holes in only the cover or only the circuit carrier are threaded can also be constructed.

It should be noted that the fasteners can also provide additional bonding between cover 40 and LED carrier 50, as well as additional heat conduction from cover 40 to the underlying substrate on which light source 30 is mounted.

It should also be noted that the holes do not need to go completely through the light source. Either the holes in the cover or the holes in the LED carrier could be blind holes that are threaded to receive a screw.

These holes can also be used during the assembly of the light source to hold cover 40 to LED carrier 50 during the filling of opening 42. The light source is assembled by attaching cover 40 to circuit carrier 50 after all of the LEDs have been affixed to circuit carrier 50 and connected electrically to the various electrical traces. Screws are placed through the holes and tightened to force cover 40 and circuit carrier 50 together. Embodiments in which the holes in only one of the cover or circuit carrier are threaded are of particular use during the assembly operation. The encapsulant is then dispensed into opening 42 and allowed to cure. After the curing is completed, the screws are removed.

Many LEDs emit a significant fraction of the light generated in the die through the side surfaces of the die. This side-emitted light is light that is trapped within the LED due to the difference in index of refraction of the LED materials and the surrounding dielectric material. The trapped light is reflected back and forth between the top and bottom surfaces of the LED until it strikes the surfaces at the edge of the die through which the light escapes.

The embodiments of the present invention discussed above utilize a single opening 42 in cover 40 through which the light from the LEDs exits. The sides of this opening are angled and reflective to re-direct light leaving the sides of the LED dies into the forward direction. Refer again to FIG. 4. The reflective sides capture and re-direct a significant fraction of the light that leaves the LEDs in a direction that is substantially parallel to the X-direction shown in FIG. 4; however, light leaving the LEDs in a direction that is substantially parallel to the Y-direction is not effectively captured. The amount of side-emitted light that is directed into the forward direction can be improved by including additional reflectors in cover 40.

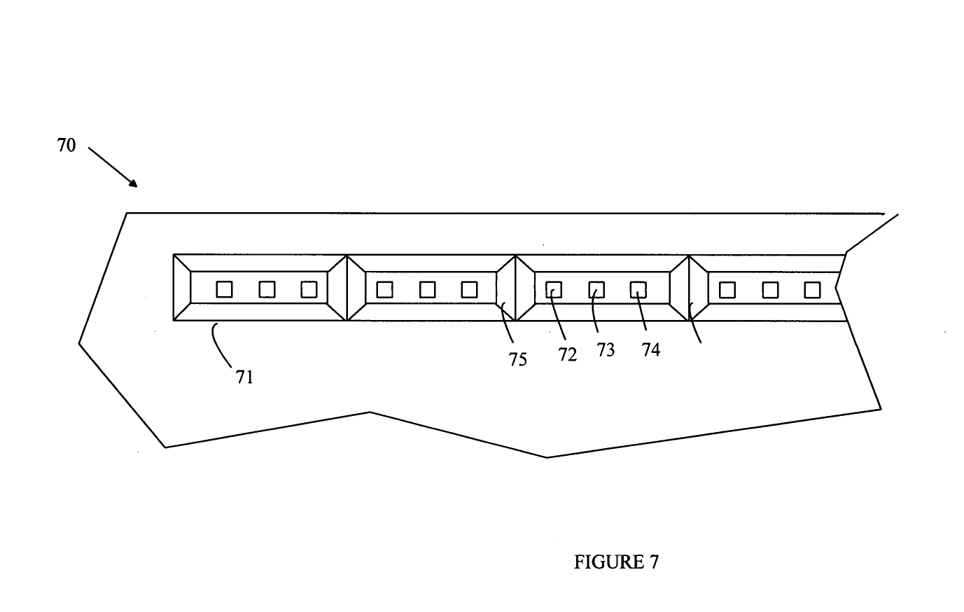

Refer now to FIG. 7, which is a top view of a portion of another embodiment of the present invention showing a portion of the opening 71 through which light from the LEDs escapes. Opening 71 has slanted, reflective sides, as discussed above. The LEDs are arranged in groups. An exemplary group is shown at 72-74. In this embodiment, each group has one red, one blue, and one green LED. Each group is bounded by reflectors 75 that redirect light leaving the sides of the LEDs in the Y-direction such that the light leaves through the top surface of opening 71. These additional reflectors are incorporated into the cover element, and hence do not require any additional fabrication steps. In principle, a reflector of the type shown in FIG. 7 could be introduced between each pair of LEDs if there is sufficient space.

The above-described embodiments of the present invention utilize red, green, and blue LEDs to implement a light source that can be tuned to provide a wide range of colors. However, the same general structure can be utilized to provide a light source having a more limited or wider range of colors. For example, the LEDs could be replaced by “white” LEDs that utilize blue emitting LEDs that are covered with a phosphor that converts part of the blue light to yellow light. The resulting output appears to be white to a human observer.

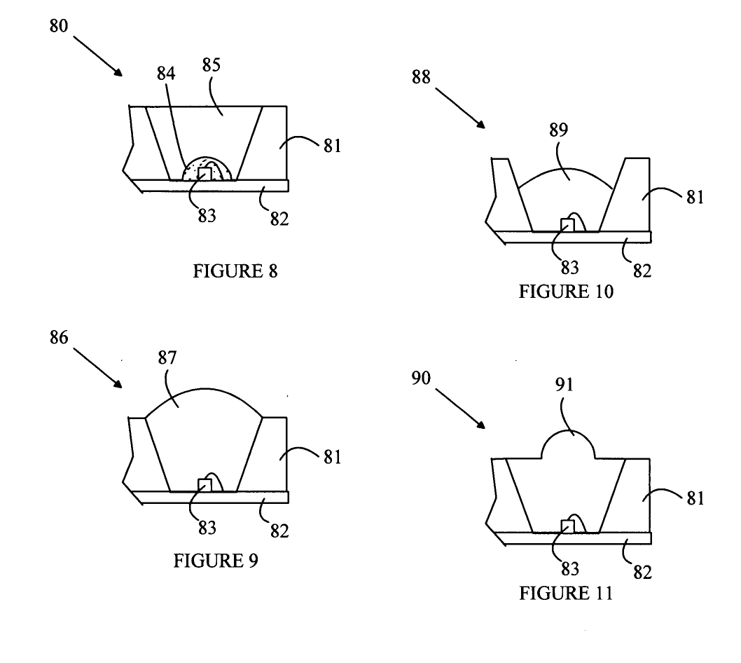

Refer now to FIG. 8, which is a cross-sectional view of a portion of another embodiment of a light source according to the present invention. Light source 80 includes an LED carrier 82 that is bonded to a cover 81. At least one of the LEDs 83 is covered with a droplet of epoxy 84 that includes particles of a phosphor that converts part of the light leaving LED 83 to light having a different spectrum. For example, LED 83 could be a blue emitting LED and the phosphor could convert a portion of the blue light to yellow light as described above to produce a white LED. It should also be noted that the phosphor layer could include a plurality of phosphors having different emission spectra. The phosphor-containing droplet is deposited and cured prior to the attachment of LED carrier 82 to cover 81. After cover 81 is positioned over LED carrier 82, the remaining space in the opening in cover 81 is filled with a clear encapsulant 85 as described above. It should be noted that the phosphor covering can be provided on selected ones of the LEDs or all of the LEDs.

In one embodiment the encapsulant system utilizes a transparent silicone. The silicone provides a low stress encapsulation that has high thermal and photo-stability during the operation of the LEDs. In another embodiment the encapsulant system utilizes thermosetting plastic polymers that are dispensed in liquid form into the opening in the cover and thereafter cured in an oven. These polymers also provide a medium of intermediate refractive index between the air and the LED chip that improves the efficiency of light extraction from the LED chips.

The above-described embodiments of the present invention utilize an encapsulant layer that is filled to the top of the cover and finished with a planar surface. However, the top surface of the encapsulant layer could also be molded. A non-planar molded surface can provide two advantages. First, the molded surface forms a lens that alters the output light profile of the light source. Second, the molded surface improves the extraction of light from the device by reducing the amount of light that is reflected at the encapsulant-air boundary.

Refer now to FIG. 9, which is a cross-sectional view of a portion of another embodiment of a light source according to the present invention. Light source 86 includes an LED carrier 82 that is bonded to a cover 81 in a manner analogous to that described above. Light source 86 utilizes an encapsulant layer 87 that has a convex surface that can act as a lens. The convex surface also reduces the amount of light from LED 83 that strikes the surface at angles greater than the critical angle to the normal to the surface, and hence, is reflected back into opening.

The lens could also be cylindrical with the axis of the cylinder parallel to a line through the LEDs. As noted above, in many applications, the light source ideally approximates a conventional linear light source. Such a cylindrical lens improves the approximation of the present invention to a conventional linear source. It should also be noted that other lens shapes including trapezoidal lens and prisms can be constructed by molding the encapsulant.

While the encapsulant lens is shown as being formed above the surface of the cover, embodiments in which the lens is formed within the opening to reduce the thickness of the light source could also be constructed. Such an embodiment is shown in FIG. 10, which is a partial cross-sectional view of another embodiment of a light source according to the present invention. Light source 88 includes an encapsulant lens 89 that is molded within the cavity.

The encapsulant lens can also be constructed such that the lens do not cover the entire surface of the encapsulant layer. Such an arrangement is shown in FIG. 11, which is a cross-sectional view of a portion of another embodiment of a light source according to the present invention. Light source 90 includes a lens 91 that is molded into the encapsulant layer and forms an image of the LED at points distant from the light source. In this type of application, light reflected from the sides of the opening is not imaged in the far field, and hence, the sides of the cover do not need to be reflective. The encapsulant lens can be an individual convex lens over each LED or a cylindrical lens that covers all of the LEDs.

The minimum width of the embodiments discussed above is determined by the size of opening 42 shown in FIG. 3 and the size of connector 32. If a light source with a reduced width is required, connector 32 can be placed at the end of the row of LEDs such that the connector does not increase the width or length of the light source.

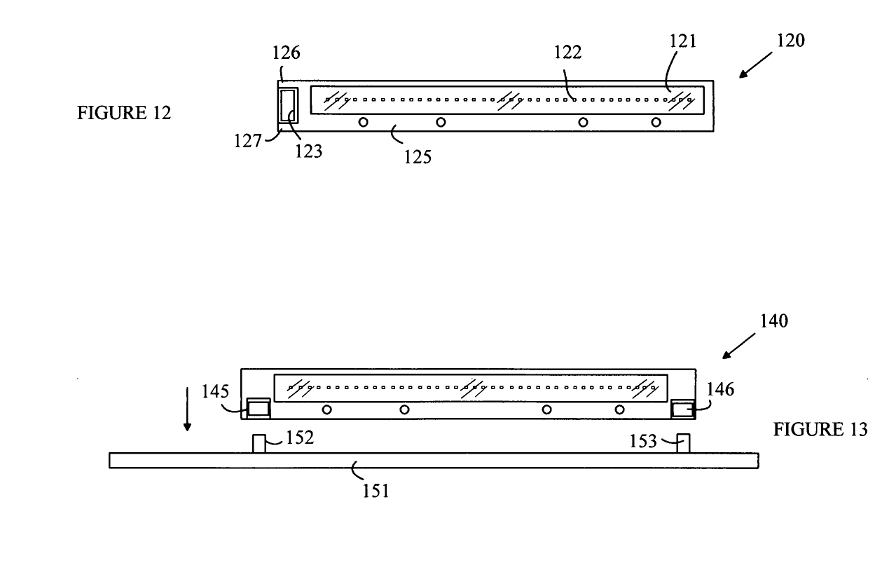

Refer now to FIG. 12, which is a top view of another embodiment of a light source according to the present invention. Light source 120 includes a plurality of LEDs 122 positioned in an opening 121 in cover 125. The LEDs are arranged on a circuit carrier that is analogous to that described above. The traces on the circuit carrier are connected to a connector 123 that is positioned in an opening in cover 125 on the end of cover 125.

While connector 123 is shown as being inset in an opening in cover 125 having three sides, it should be noted that sides 126 and 127 are optional. That is, cover 125 could merely terminate leaving the portion of the underlying circuit carrier having the connector pads exposed.

In the above-described embodiments, a single connector has been utilized. However, embodiments having multiple connectors could also be constructed. Such embodiments are particularly useful in designs in which the connectors also provide a means for mounting the light source in a device utilizing the light source. Refer now to FIG. 13, which is a top view of another embodiment of a light source according to the present invention. Light source 140 includes two connectors shown at 145 and 146. These connectors are positioned to mate with two corresponding connectors 152 and 153 on a substrate 151 that is part of a device in which the light source is utilized. The connectors provide both electrical connections to substrate 151 as well as mechanical connections.

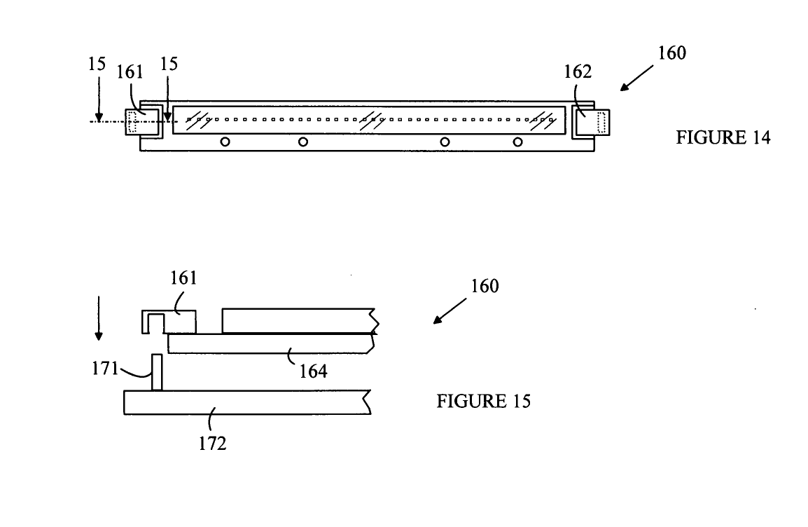

Refer now to FIGS. 14 and 15, which illustrate another embodiment of a light source according to the present invention. FIG. 14 is a top view of light source 160, and FIG. 15 is a cross-sectional view of light source 160 through line 15-15 shown in FIG. 14. Light source 160 also includes two connectors shown at 161 and 162. These connectors extend over the edge of circuit carrier 164. Each connector mates with a corresponding connector 171 on a substrate 172 on which light source 160 is mounted. In this embodiment, the bottom surface of circuit carrier 164 is in contact with substrate 172 to provide improved heat conduction. Once again, the connectors provide both electrical and mechanical connections.

In one embodiment, the cover is constructed from metallic materials to provide high thermal conductivity (typically between 50 to 350 W/m.K) for efficient heat dissipation. Metallic materials are inexpensive and easily formed into various shapes. In addition, such materials can be plated to provide the reflective surfaces discussed above. In one embodiment, the cover is plated with nickel. In one embodiment, the cover is constructed from an aluminum alloy. Aluminum is a cost effective cover material relative to other choices such as ceramics and metal-plated polymers.

In the above-described embodiments of the present invention, the top surface of the cover is smooth except for the openings for the screws and LEDs. However, embodiments in which the surface of the cover is provided with heat fins or other surface area enhancing features to better dissipate heat to the surrounding air could be constructed provided the heat dissipating features do not interfere with the mounting of the light source in the final product. It should be noted that providing the non-light reflecting circuits with a black coating by painting or anodizing could be utilized to further increase the heat transfer without altering the physical profile of the light source.

The above-described embodiments have utilized covers constructed from a metal such as an aluminum alloy. However, embodiments in which the cover is constructed from ceramics, composites, or plastics could also be constructed. Such materials can be plated in the area of the opening to provide a reflective surface.

Various modifications to the present invention will become apparent to those skilled in the art from the foregoing description and accompanying drawings. Accordingly, the present invention is to be limited solely by the scope of the following claims.

What is claimed is:

1. A light source comprising:
a plurality of LEDs;
an LED carrier comprising a metallic core having a top and bottom surface, said top surface being bonded to a circuit layer having mounting pads for each of said LEDs and a first connector that provides connections to circuit conductors connected to said mounting pads, said bottom surface comprising an external boundary of said light source;
a cover bonded to said LED carrier, said cover comprising a first opening positioned to allow light from said LEDs to leave said cover and a second opening that provides access to said first connector; and
an encapsulant system that covers each of said LEDs with a layer of encapsulant material.

2. The light source of claim 1 wherein said LED carrier further comprises mounting pads for a second connector that provides connections to circuit conductors connected to those mounting pads, and wherein said cover further comprises a third opening that provides access to said second connector.

3. The light source of claim 1 wherein said metal core has a thermal conductivity greater than 10 W/m.K at 25 degrees Centigrade.

4. The light source of claim 1 wherein said cover comprises aluminum plated with nickel on a surface of the said first opening.

5. The light source of claim 1 wherein said cover comprises a cavity, said LED carrier being bonded to an inside surface of said cavity, said LED carrier being aligned to said cover by said walls of said cavity.

6. The light source of claim 1 wherein said circuit layer comprises a thermally conductive insulator having a thickness of less than 4 mils having a first surface bonded to said metallic core and a second surface bonded to said circuit conductors.

7. The light source of claim 1 wherein said encapsulant system comprises a layer of clear encapsulant having a first surface in contact with said LEDs and said LED carrier and a second surface that is substantially flat.

8. The light source of claim 1 wherein said encapsulant system comprises a layer of clear encapsulant having a first surface in contact with said LEDs and said LED carrier and a second surface that is cylindrical.

9. The light source of claim 1 wherein said encapsulant system comprises a layer of clear encapsulant having a first surface in contact with said LEDs and said LED carrier and a second surface comprising a plurality of convex dome-shaped lenses, one such lens corresponding to each of said LEDs.

10. The light source of claim 1 wherein said encapsulant system comprises a first encapsulant having phosphor particles suspended therein overlying at least one of said LEDs and a second clear encapsulant overlying said first encapsulant layer.

11. The light source of claim 1 further comprising first and second holes in said cover and said LED carrier, said first and second holes in said cover being aligned with said first and second holes in said LED carrier.

12. The light source of claim 1 wherein one of said first and second holes comprises a threaded portion.

13. The light source of claim 1 wherein said LEDs are arranged in a linear array having at least one row of LEDs that is parallel to one side of said first opening.

14. A method for constructing a light source comprising:
providing an LED carrier comprising a metallic core having a top and bottom surface, said top surface being bonded to a circuit layer having LED mounting pads for each of a plurality of LEDs and connector mounting pads for a connector that provides connections to circuit conductors connected to said mounting pads, said bottom surface comprising an external boundary of said light source;
mounting LEDs to each of said mounting pads;
mounting said connector to said connector mounting pads;
positioning a cover comprising a first opening positioned to allow light from said LEDs to leave said cover and a second opening that provides access to said connector with respect to said LED carrier; and
bonding said cover to said LED carrier.

15. The method of claim 14 wherein said bonding comprises dispensing encapsulant into said first opening.

16. The method of claim 14 wherein said positioning comprises connecting said cover and LED carrier with a fastener that passes through a hole in said LED carrier and said cover.

17. The method of claim 14 wherein said mounting of said LEDs comprises covering one of said LEDs with an encapsulant comprising particles of a phosphor material.

18. The method of claim 14 wherein said positioning comprises inserting said LED carrier into a cavity in said cover.

19. The method of claim 14 wherein said bonding comprises dispensing clear encapsulant into said first opening and molding a non-planar feature into a surface of said encapsulant that is not in contact with said LED carrier.
